(19) United States
(12) Patent Application Publication
(10) Pub. No.: US 2026/0188799 A1
(43) Pub. Date: Jul. 2, 2026

(54) MULTILAYER FILM FOR A SECONDARY BATTERY POUCH AND A POUCH-TYPE SECONDARY BATTERY USING THE SAME

(71) Applicant: DONGWON SYSTEMS CORPORATION, Seoul (KR)

(72) Inventors: Eui Hwan SONG, Seoul (KR); Sung Gi YOON, Cheonan-si (KR); Hyun Ah LEE, Sejong-si (KR); Gyu Woon JUNG, Ansan-si (KR); Jong An KIM, Sejong-si (KR); Seong Weon JANG, Suwon-si (KR); Seung Hyeon YEON, Bucheon-si (KR); Hyeong Hoon KIM, Suwon-si (KR); Pyeong Wook KIM, Seoul (KR)

(73) Assignee: DONGWON SYSTEMS CORPORATION, Seoul (KR)

(21) Appl. No.: 19/050,270

(22) Filed: Feb. 11, 2025

(30) Foreign Application Priority Data
Dec. 27, 2024 (KR) 10-2024-0198545

(51) Int. Cl. H01M 50/129; H01M 50/105; H01M 50/124

(52) U.S. Cl. CPC H01M 50/129; H01M 50/105; H01M 50/1243; H01M 50/1245

(57) ABSTRACT

A multilayer composite film for a secondary battery pouch having a storage portion concavely processed on one side to accommodate an electrode assembly therein. The multilayer composite film includes a first outer layer; a second outer layer; a barrier layer; and an inner resin layer, wherein the inner resin layer has a PER (Propylene-Ethylene Rubber) content of 5% or more and 40% or less. The composite film of the pouch cell for secondary batteries according to the present invention secures excellent insulation resistance by improving the residual rate after forming.

### CROSS-REFERENCE TO RELATED APPLICATIONS

This application claims the benefit of Korean Application No. 10-2024-0198545, filed Dec. 27, 2024, in the Korean Intellectual Property Office. All disclosures of the document named above are incorporated herein by reference.

### TECHNICAL FIELD

The present invention relates to a multilayer film for a secondary battery pouch and a pouch-type secondary battery using the same, and more specifically, to a multilayer film for a secondary battery pouch with improved insulating performance and a pouch-type secondary battery using the same.

### BACKGROUND ART

Recently, the use of energy sources to replace chemical fuels is increasing, and among these, lithium secondary batteries convert chemical energy into electrical energy, have a high energy density, and can be reused through multiple charging and discharging cycles, so they are used in various ways. Lithium secondary batteries enable the miniaturization and weight reduction of devices, and are used as core components that power everything from IT devices for mobile communications to electric vehicles, as well as power sources for portable electronic devices used in modern people's daily lives.

These lithium secondary batteries comprise a cathode, an anode, an electrolyte, a separator, and an outer packaging material that packages them. The outer packaging material includes cylindrical cans, square cans, and pouches. Among these, pouches have the advantage of being easy to form into various shapes, so they are used in various ways.

On the other hand, as lithium secondary batteries become more capable, the stability of lithium secondary batteries is also being considered, and various studies are being conducted to improve the properties of pouches.

Secondary batteries are rechargeable batteries, and are mainly used in electric vehicles and electronic devices. The cell pouch for secondary batteries protects the electrolyte and electrodes inside the secondary battery, and this pouch plays an important role in safely wrapping the battery and protecting it from impacts and external environments.

One of the important parts of this pouch is the inner resin layer, which plays an important role in determining the durability and performance of the pouch. The inner resin layer refers to an inner layer made of, for example, polypropylene and the formability (ability to maintain the shape well after forming) of the pouch can vary depending on the characteristics of this material.

(Related Art) Japanese Patent Application Publication No. 2005-183820

### DISCLOSURE

### Technical Issues

The purpose of the present invention is to secure excellent insulation resistance by improving the residual rate after forming a pouch for a secondary battery.

### Technical Solution

According to one aspect of the present invention, a multilayer composite film for a secondary battery pouch having a storage portion concavely processed on one side to accommodate an electrode assembly therein comprises a first outer layer; a second outer layer; a barrier layer; and an inner resin layer, wherein the inner resin layer has a PER (Propylene-Ethylene Rubber) content of 5% or more and 40% or less.

The corner portion of the storage portion may have a residual ratio of 40% or more.

The corner portion of the storage portion may have an R value in the range of 0.3 to 4.2.

The internal resin layer may be formed with a two-layer structure including a sealing layer and an adhesive layer that combines the sealing layer and the barrier layer.

The inner resin layer may be formed with a three-layer structure including a sealing layer, a core layer, and an adhesive layer that combines the core layer and the barrier layer.

The PER content may be the total PER content included in a multilayer structure of the internal resin layer.

### Advantageous Effects

The composite film of the pouch cell for secondary batteries according to the present invention secures excellent insulation resistance by improving the residual rate after forming.

### DESCRIPTION OF DRAWINGS

These and/or other aspects will become apparent and more readily appreciated from the following description of the embodiments, taken in conjunction with the accompanying drawings in which:

FIG. 1 is a photograph showing a process for measuring a corner residual ratio according to one embodiment of the present invention.

### DETAILED DESCRIPTION OF EMBODIMENTS

Hereinafter, embodiments of the present invention will be described with reference to the attached drawings. Unless otherwise defined or stated, terms indicating directions used in this description are based on the state shown in the drawings. In addition, the same reference numerals refer to the same members throughout each embodiment. Meanwhile, each component shown in the drawings may have its thickness or dimension exaggerated for convenience of explanation, and it does not mean that it must be configured with the ratio between the corresponding dimensions or components in reality.

In order to increase the capacity of the battery, the forming depth of the pouch should be increased so that more electrodes and electrolytes can be contained.

However, if the forming depth is too deep, the thickness of the pouch may become thinner and the insulation performance may deteriorate. To solve this problem, the main technical feature of the present invention is to improve the pouch to maintain its thickness well even after forming by adjusting the PER content and the forming depth.

Regarding the PER (Propylene-Ethylene Rubber) content, PER is a rubber material composed of a copolymer of polypropylene (PP) and ethylene, and has excellent flexibility and impact resistance. PER plays an important role in improving the formability and residual rate of the film, and in particular, it helps to maintain the physical properties of the film even during deep forming by alleviating the stress generated during forming.

In this embodiment, the residual rate is increased after forming using a pouch cell composite film for a secondary battery by adjusting the PER content. The higher the PER content, the higher the residual rate at the corner, and the better the insulation resistance performance.

At this time, the residual rate at the corner refers to the ratio of the thickness remaining after forming. For example, a residual ratio of 50% means that 50% of the original thickness is maintained. Therefore, the maximum value of the residual ratio at the corner portion after forming cannot be 100%.

The present invention aims to improve the insulation resistance by increasing the residual ratio after forming while increasing the forming depth of the pouch-shaped cell.

The PER content is set to a range of 7% to 40%, which is an optimized value to maintain the residual ratio at the corner portion after forming at 40% or more to exhibit excellent insulation resistance. As the PER content increases, the flexibility of the film increases, allowing deeper forming during the forming process. When the PER is less than 7%, the flexibility of the film is insufficient, which reduces the formability, and the residual ratio at the corner portion after forming may fall below 40%, and when the PER exceeds 40%, the mechanical strength of the film after forming may be reduced due to excessive flexibility, which may have a negative effect on durability and insulation performance.

In this embodiment, the forming depth is set to a maximum of 7.5 mm, and the residual ratio at the corner portion after forming is important. When the residual ratio is 40% or higher, it exhibits excellent insulation resistance (over 50 MΩ), which ensures the electrical stability of the pouch-type cell. PER (Propylene-Ethylene Rubber) plays a key role in improving the formability and insulation performance of the pouch-type cell.

By appropriately adjusting the PER content, the film can exhibit excellent performance in all of its formability, residual ratio, and insulation resistance.

The following is a detailed explanation.

The film of the pouch-type secondary battery is composed of a multilayer structure, and each layer performs a specific function. The innermost layer is the sealing layer, which directly contacts the electrolyte. The sealing layer is mainly composed of resins such as polypropylene (PP) and polyethylene (PE), and provides heat sealing and chemical stability to prevent electrolyte leakage. This sealing layer and adhesive layer are also called the inner resin layer, and play an important role in maintaining the structural stability of the film.

The adhesive layer is a layer that combines the sealing layer and the barrier layer, preventing delamination between layers and maintaining structural integrity. The adhesive layer uses materials such as Maleic Anhydride Grafted PP or EAA (Ethylene Acrylic Acid). At this time, the adhesive layer mainly strengthens the bonding strength with the barrier layer to increase the stability of the film.

In addition to this 2-layer configuration, there is a 3-layer configuration including a core layer between the sealing layer and the adhesive layer. The core layer provides additional structural strength and flexibility to the film, and improves the forming depth by alleviating stress during the forming process. The core layer comprises polymer materials such as polypropylene (PP), ethylene-propylene rubber (EPDM), and propylene-ethylene rubber (PER), optimizing the durability and formability of the film.

A barrier layer is located on the inner resin layer. The barrier layer protects the internal battery by blocking the penetration of oxygen (O₂), moisture (H₂O), and other gases. Mainly aluminum (AI) or EVOH (Ethylene Vinyl Alcohol) is used to maintain the life and stability of the battery. The barrier layer is a key layer that protects the inside of the battery from the external environment.

The base layer is located above the barrier layer, which serves as the center of the film. It is composed of polyethylene terephthalate (PET), nylon, or polypropylene (PP), and provides structural strength and thermal stability to the film. The base layer prevents deformation during the forming process and enables the film to withstand external impacts.

The outer layer can be located at the outermost layer. The outer layer protects the film from the external environment and stably maintains the inner layer from mechanical impact, moisture, and temperature changes. The outer layer is composed of polyethylene terephthalate (PET) or nylon, and a special coating is applied as needed to enhance durability. The outer layer provides printability, allowing product information and brand logos to be displayed.

This multilayer structure maximizes the performance and safety of the pouch-type secondary battery by mutually complementing the functions of each layer, such as durability, gas barrier, and heat sealing, depending on the two- or three-layer configuration of the inner resin layer. In particular, the three-layer configuration is designed to enable deep forming while maintaining structurally higher stability, thereby ensuring the long-term reliability of the battery. The inner layer of the resin layer according to the present embodiment uses modified polypropylene and serves to increase adhesion with a barrier layer (metal layer) or other polymer layers. The core layer is composed of a polypropylene-based resin and serves to improve formability and durability. The PER content according to the present embodiment refers to the total PER content included in the multilayer structure of the inner resin layer, and control or regulation of the PER content refers to adjusting the total PER content included in the inner resin layer.

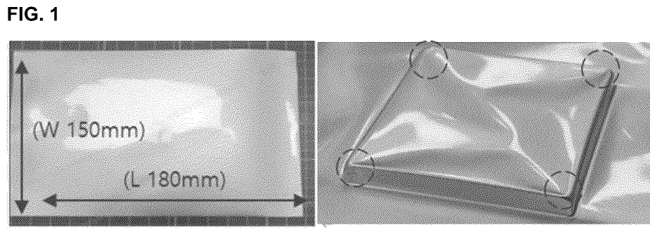

Referring to FIG. 1, the method for measuring the residual rate at the corner portion is as follows.

In order to measure the residual rate at four R-sections after forming, a Digimatic Gear Thickness Micrometer (Mitutoyo 324-251) was used as the equipment.

As shown in FIG. 1, first, a cell pouch sample is cut (a) and formed to the target forming depth (b). At this time, the target forming depth is fixed to 7.5 mm.

Next, four corners of the formed sample are cut (c). After that, the zero point is confirmed by repeatedly using a micrometer several times (d), and the thickness of the unformed portion is measured several times (e). After that, the inside of the corner is measured with a micrometer (f), and the zero point adjustment and residual 3-point measurement are repeated (g).

The results according to this measurement method are as follows. Table 1 shows the results of corner residual rate measurement according to PER content (comparative example), and Table 2 shows the results of corner residual rate measurement according to PER content (example).

TABLE 1

| Comparative Example 1 | | | | | Comparative Example 2 | | | | |
|---|---|---|---|---|---|---|---|---|---|
| PER 3% | | | | | PER 5% | | | | |
| No. | R1 | R2 | R3 | R4 | No. | R1 | R2 | R3 | R4 |
| 1 | 35% | 34% | 35% | 35% | 1 | 38% | 38% | 39% | 38% |
| 2 | 33% | 35% | 35% | 34% | 2 | 35% | 36% | 39% | 36% |
| 3 | 35% | 33% | 35% | 35% | 3 | 33% | 36% | 38% | 38% |

| | | | |
|---|---|---|---|
| Avg | 35% | Avg | 37% |

TABLE 2

| Example 1 | | | | | Example 2 | | | | |
|---|---|---|---|---|---|---|---|---|---|
| PER 7% | | | | | PER 10% | | | | |
| No. | R1 | R2 | R3 | R4 | No. | R1 | R2 | R3 | R4 |
| 1 | 40% | 37% | 40% | 39% | 1 | 44% | 43% | 41% | 42% |
| 2 | 41% | 38% | 39% | 39% | 2 | 43% | 42% | 41% | 40% |
| 3 | 42% | 39% | 41% | 40% | 3 | 42% | 44% | 38% | 43% |
| Avg | 40% | | | | Avg | 42% | | | |
| Example 3 | | | | | Example 4 | | | | |
| PER 12% | | | | | PER 15% | | | | |
| No. | R1 | R2 | R3 | R4 | No. | R1 | R2 | R3 | R4 |
| 1 | 46% | 46% | 48% | 47% | 1 | 48% | 48% | 48% | 47% |
| 2 | 42% | 43% | 47% | 42% | 2 | 47% | 46% | 47% | 48% |
| 3 | 40% | 43% | 46% | 46% | 3 | 48% | 47% | 48% | 48% |
| Avg | 45% | | | | Avg | 48% | | | |
| Example 5 | | | | | Example 6 | | | | |
| PER 20% | | | | | PER 25% | | | | |
| No. | R1 | R2 | R3 | R4 | No. | R1 | R2 | R3 | R4 |
| 1 | 53% | 52% | 49% | 51% | 1 | 55% | 54% | 52% | 52% |
| 2 | 52% | 51% | 48% | 48% | 2 | 55% | 55% | 55% | 55% |
| 3 | 51% | 53% | 46% | 52% | 3 | 54% | 55% | 55% | 54% |
| Avg | 51% | | | | Avg | 54% | | | |
| Example 7 | | | | | Example 8 | | | | |
| PER 30% | | | | | PER 35% | | | | |
| No. | R1 | R2 | R3 | R4 | No. | R1 | R2 | R3 | R4 |
| 1 | 56% | 54% | 55% | 56% | 1 | 57% | 58% | 58% | 57% |
| 2 | 55% | 57% | 56% | 55% | 2 | 58% | 57% | 59% | 56% |
| 3 | 57% | 55% | 58% | 54% | 3 | 57% | 59% | 58% | 59% |

| | | | |
|---|---|---|---|
| Avg | 56% | Avg | 58% |

Example 9
PER 40%

| No. | R1 | R2 | R3 | R4 |
|---|---|---|---|---|
| 1 | 62% | 60% | 59% | 60% |
| 2 | 60% | 62% | 60% | 59% |
| 3 | 61% | 60% | 60% | 61% |

| | |
|---|---|
| Avg | 60% |

In this test, each was divided into Comparative Examples 1 and 2 and Examples 1 to 9, and three samples were formed and the residual rate was measured. Here, No. 1, 2, and 3 are numbers that distinguish each sample.

Tables 1 and 2 show the results of the experiment on the residual rate at the corner portion according to the PER (Propylene-Ethylene Rubber) content. In each experiment, the thickness of the corner was measured after forming by changing the PER content. As the PER content increases, the residual rate at the corner portion tends to increase. The higher the residual rate, the better the thickness of the pouch is maintained after forming.

In this way, as the PER content increases, the residual rate at the corner portion increases, and the thickness of the pouch is well maintained after forming, which plays an important role in improving the durability and insulation performance of the pouch. In particular, the residual rate was confirmed to be 40% or more in the examples. When comparing the insulation resistance data of Comparative Example 1 (residual rate 35%/PER content 5%) and Example 1 (residual rate 40%/PER content 7%), it was confirmed that the insulation resistance data of Example 1 was superior.

As a result, the higher the PER content, the higher the corner residual rate, which means that the material is better maintained after being formed. This is because the higher the PER content, the more solid the material is formed during the forming process, and the greater the ability to restore the original thickness after the pouch is deformed.

### <Insulation Performance>

After injecting the electrolyte to create an insulation resistance 60×80 dummy cell, the insulation resistance value was measured and recorded by applying 100 V to the aluminum tab portion and the aluminum side portion of the pouch using an insulation resistance meter.

That is, a 150×180 mm sample was cut, and the sample was formed to a depth of 4 mm. At this time, the R value of the corner portion was set to have a value in the range of 0.3 to 4.2.

After that, the electrolyte was injected and left in an oven at 80° C. After leaving, the insulation resistance was measured at set times on the 1st, 2nd, 3rd, and 4th days. If it was 50 M 9, it was considered as an example, and if it was less than that, it was considered as a comparative example.

TABLE 3
Examples of insulation resistance measurement
according to residual ratio (unit: GΩ)

| | | | | | |
|---|---|---|---|---|---|
| | | +1st day | +2nd day | +3rd day | +4th day |
| SPL | No. | @80° C. | @80° C. | @80° C. | @80° C. |

Comparative Example 1 Insulation Resistance Measurement Data
(residual rate 35%/PER content 5%)

| | | | | | |
|---|---|---|---|---|---|
| A | 1 | 674.812 | 0.850 | 0.003 | 0.008 |
| | 2 | 263.287 | 0.055 | 0.003 | 0.005 |
| | 3 | 271.998 | 0.005 | 0.002 | 0.001 |
| | 4 | 457.817 | 0.030 | 0.004 | 0.003 |
| | 5 | 4205.93 | 173.087 | 0.009 | 0.003 |
| | 6 | 1532.63 | 206.970 | 0.005 | 0.001 |
| | 7 | 435.267 | 130.015 | 0.023 | 0.001 |
| | 8 | 385.658 | 216.845 | 0.002 | 0.001 |
| | 9 | 128.931 | 0.730 | 0.007 | 0.002 |
| | 10 | 674.812 | 288.239 | 0.850 | 0.003 |

| | | | | |
|---|---|---|---|---|
| NG number | 0 | 2 | 9 | 10 |
| NG rate (%) | 0 | 20 | 90 | 100 |

Example 1 Insulation Resistance Measurement Data
(residual rate 40%/PER content 10%)

| | | | | | |
|---|---|---|---|---|---|
| B | 1 | 295.432 | 204.389 | 177.661 | 37.614 |
| | 2 | 217.868 | 193.176 | 145.222 | 1.258 |
| | 3 | 367.039 | 334.176 | 265.983 | 181.291 |
| | 4 | 296.446 | 194.304 | 166.347 | 4.557 |
| | 5 | 367.039 | 334.176 | 265.983 | 181.291 |
| | 6 | 766.503 | 332.926 | 270.870 | 189.116 |
| | 7 | 281.058 | 187.221 | 181.049 | 157.395 |
| | 8 | 354.144 | 226.401 | 216.847 | 36.272 |
| | 9 | 351.500 | 299.692 | 224.047 | 153.642 |
| | 10 | 302.189 | 287.470 | 189.301 | 49.322 |

| | | | | |
|---|---|---|---|---|
| NG number | 0 | 0 | 0 | 0 |
| NG rate (%) | 0 | 0 | 0 | 0 |

As can be seen in Table 3, product B was confirmed to exhibit excellent insulation resistance. In other words, the better the residual ratio, the better the insulation resistance results were confirmed.

The insulation resistance of each sample was measured from day 1 to day 4 at 80 degrees Celsius.

In the comparative example, the insulation resistance was high on day 1, but it decreased rapidly from day 2. From day 3, most samples showed very low insulation resistance values, indicating that the insulation performance was poor.

In the example, the insulation resistance was maintained relatively stably until day 4, and the insulation resistance performance was superior to the comparative example, but the insulation resistance tended to decrease in the long term.

As the residual ratio at the corner portion increases, the insulation performance also improves. When the residual ratio is 40% or higher, the pouch exhibited excellent insulation performance. This is because the corner maintains its thickness well even after forming, preventing the current from leaking out. Therefore, as the PER content increases, the residual ratio at the corner portion after forming increases, which ultimately becomes an important factor in improving the insulation resistance performance.

As a result, it was confirmed that there was a difference in the corner residual rate depending on the total PER content, and it was confirmed that excellent insulation resistance was exhibited when the residual rate was 40% or higher.

Although the preferred embodiments of the present invention have been described above, the technical idea of the present invention is not limited to the preferred embodiments described above, and can be implemented in various ways within a scope that does not deviate from the technical idea of the present invention embodied in the patent claims.

1. A multilayer composite film for a secondary battery pouch having a storage portion concavely processed on one side to accommodate an electrode assembly therein comprising:
a first outer layer;
a second outer layer;
a barrier layer; and
an inner resin layer,
wherein the inner resin layer has a PER (Propylene-Ethylene Rubber) content of 5% or more and 40% or less.

2. The composite film of claim 1, wherein a corner portion of the storage portion has a residual ratio of 40% or more and an insulation resistance of 50 MΩ or more.

3. The composite film of claim 1, wherein a corner portion of the storage portion has an R value in the range of 0.3 to 4.2.

4. The composite film of claim 1, wherein the internal resin layer is formed with a two-layer structure including a sealing layer and an adhesive layer that combines the sealing layer and the barrier layer.

5. The composite film of claim 1, wherein the inner resin layer is formed with a three-layer structure including a sealing layer, a core layer, and an adhesive layer that combines the core layer and the barrier layer.

6. The composite film of claim 4, wherein the PER content is the total PER content included in a multilayer structure of the internal resin layer.

7. The composite film of claim 5, wherein the PER content is the total PER content included in a multilayer structure of the internal resin layer.

8. A secondary battery comprising the composite film according to claim 1.

9. A secondary battery comprising the composite film according to claim 2.

10. A secondary battery comprising the composite film according to claim 3.

11. A secondary battery comprising the composite film according to claim 4.

12. A secondary battery comprising the composite film according to claim 5.
